(19) United States
(12) Patent Application Publication
(10) Pub. No.: US 2025/0267146 A1
(43) Pub. Date: Aug. 21, 2025

(54) SYSTEMS AND METHODS FOR WEB 3.0 AND BEYOND-ENABLED MULTI-SYSTEM, MULTI-CLIENT, CYBER-RESILIENT DATA EXCHANGE PLATFORM LEVERAGING PERMISSION BLOCKCHAIN, EDGE COMPUTING, AND FEDERATED LEARNING TECHNOLOGY

(71) Applicant: SOFTHREAD, INC., Severna Park, MD (US)

(72) Inventors: Eliot Siegel, Orlando, FL (US); Ingrid Vasiliu-Feltes, Miami, FL (US); Stephen Dennis, Columbia, MD (US)

(21) Appl. No.: 19/055,362

(22) Filed: Feb. 17, 2025

Related U.S. Application Data
(60) Provisional application No. 63/553,931, filed on Feb. 15, 2024.

(51) Int. Cl. H04L 9/40; G06F 21/62

(52) U.S. Cl. CPC H04L 63/10; G06F 21/6245

(57) ABSTRACT

Techniques are described herein for a Web 3.0-Enabled Cyber-Resilient Data Exchange Platform Leveraging Permission Blockchain, Edge Computing, and Federated Learning Technology, which is configured to enhance the privacy, confidentiality, cyber-resilience, and operational efficiency of multi-system, multi-client, multi-directional data exchanges among client users, devices, servers, cloud environments, and a decentralized web architecture or other applications within one network or a system of networks by deploying edge computing, federated learning models, and permissioned blockchain technology that uses threshold cryptographic primitives and the key primitive of permissioned blockchains called Byzantine fault-tolerant (BFT) protocol, combined with fine-grained access control, pub/sub capabilities and a novel private chaincode functionality during industry-agnostic operations. Techniques, methods, processes, and systems described herein enhance operational efficiency by increasing operational processing speed and reducing operational processing time for industry-agnostic operations within the described industry-agnostic platform.

### CROSS-REFERENCE TO RELATE APPLICATIONS

This application claims priority to co-pending U.S. Provisional Patent Application Ser. No. 63/553,931, filed Feb. 15, 2024, the entire disclosure of which is incorporated herein by reference.

### FIELD OF THE INVENTION

The present invention disclosure relates generally to systems and methods for industry-agnostic data exchanges that occur among systems of networks, networks, servers, devices, or other cloud-enabled technology applications. More specifically, the present invention is concerned with a Web 3.0-Enabled, Cyber-Resilient, Data Exchange Platform Leveraging Permissioned Blockchain, Edge Computing, and Federated Learning Technology, offering decentralized, attribute-based, fine-grained access control, confidentiality-preserving, data exchange, and analytics capabilities.

BACKGROUND

The rapid pace of technological advancement has transformed our world, and the proliferation of connected devices has become a ubiquitous feature of modern life. With the impending arrival of Web 3.0, 4.0, and 5.0, the number of connected devices in the industrial Internet of Things (IIoT) and the Internet of Things (IoT) is expected to grow exponentially. However, the widespread adoption of these new technologies raises essential concerns about privacy and cybersecurity.

As we transition towards a decentralized Web 3.0, the foundational role of privacy and zero-trust cybersecurity cannot be overstated. The decentralized nature of Web 3.0 means that users will have more control over their data and will not rely on centralized entities such as tech giants or governmental agencies to protect their personal information. However, this also means that users will have increased responsibility for their privacy and cybersecurity and must take proactive measures to safeguard their data.

The concept of zero-trust cybersecurity is essential in this context. Zero-trust cybersecurity is a model that requires all users, whether inside or outside the network, to be authenticated and authorized for every interaction with system resources. This model assumes that all users are potential threats and controls lateral action in the system to minimize the risk of a cyber-attack. By implementing a zero-trust cybersecurity approach, Web 3.0 ecosystems and applications will offer a more secure and reliable environment for user interaction and data protection.

The growing number of connected devices in the industrial Internet of Things (IIoT) and the Internet of Things (IoT) significantly increases the attack surface, posing complex privacy protection and cybersecurity challenges. These devices collect sensitive and private data, which, if compromised, could have serious consequences. Additionally, these devices often need to be designed with security in mind and may be easily exploited by cybercriminals. To address these challenges, it is essential to deploy robust security measures that may protect devices and the data they collect.

Permissioned blockchain technology, edge computing, and federated learning are three key technologies that may be leveraged to improve privacy and cybersecurity in current and novel decentralized web 3.0 (or beyond) configurations. Permissioned blockchain technology may provide a secure, appropriate, and transparent way to store and share data while edge computing continues to enable efficient data processing and analysis. Further, analytic automation, e.g., federated search, learning, and modeling, can be enabled over multiple devices without exchanging, copying, or aggregating sensitive data.

In combination, these technologies significantly improve confidentiality and cyber-resilience for data and information exchanges in decentralized Web 3.0 and beyond configurations. By deploying the appropriate permissioned blockchain technology, users may ensure that their data are protected and only accessible to authorized parties. Edge computing may enable real-time processing of data, which is essential for many IIoT and IoT applications. Analytic automation, such as federated learning, may enable multiple devices to collaborate in training machine learning models without sharing sensitive data.

The industry need for data security and privacy has become more critical as the world moves towards a more connected future with the rise of the Internet of Things (IoT) and Industry 4.0 (the Fourth Industrial Revolution). Currently, available technology platforms address confidentiality and security in a siloed fashion, leaving vulnerabilities for cyber-attacks and ethical violations. While permissionless blockchains provide security through distributed consensus, they are expensive, do not offer data confidentiality, and may compromise data privacy. In contrast, permissioned blockchain, edge computing, and analytic automation, such as federated learning, offer a comprehensive solution to these issues. Permissioned blockchain technology, unlike permissionless blockchain technology, enables control over the network by limiting participation and restricting access to computing resources and sensitive data. This feature ensures that sensitive data and computation are only accessible to authorized parties, thus maintaining confidentiality and privacy.

Alternatively, edge computing involves processing data at the network edge rather than in a centralized data center. This approach reduces latency and improves the efficiency of data processing. Moreover, edge computing may reduce the risk of data breaches by keeping sensitive data close to the source rather than transmitting it to a centralized server, which could be vulnerable to interception and attacks.

For analytic automation, federated learning is a machine learning approach that allows multiple parties to collaborate on building a predictive model without copying or sharing sensitive data elements. In this approach, data is stored and processed locally, and only the model updates are shared, perhaps with a central server. This approach enhances data privacy and can be highly efficient, reducing the risk of data breaches by limiting the transmission of sensitive data.

To address these challenges, our innovation offers an engineering solution that leverages the advantages of permissioned blockchain, edge computing, and federated learning to provide a comprehensive, easily scalable, and deployable solution for high-volume data exchanges in highly regulated industries. A vital advantage of this approach is that it enables the creation of a trusted network that enables secure and efficient data sharing between authorized parties while ensuring the confidentiality and integrity of sensitive information.

In a multi-cloud environment, this federated learning module could be implemented by establishing a set of protocols and interfaces that allow the nodes to communicate with each other across different cloud providers. The federated learning algorithm must be designed to handle the heterogeneity of the data and the devices and the variability of the network connectivity and latency.

To ensure the privacy and security of the data, a range of cryptographic techniques could be employed, such as differential privacy, homomorphic encryption, and secure multi-party computation. These techniques allow the nodes to perform computations on encrypted data without revealing the underlying data or model parameters.

To enable effective collaboration among the stakeholders, a federated learning platform must provide a range of tools and APIs that allow the stakeholders to manage the data and the model parameters, monitor the training progress, and visualize the results. The platform must also provide a mechanism for resolving conflicts and ensuring that the business rules and policies are enforced consistently.

While the transition towards Web 3.0, 4.0, and 5.0 represents a significant opportunity to improve privacy and cybersecurity, it poses significant privacy and security challenges that must be addressed. The combined deployment of permissioned blockchain technology, edge computing, and federated learning may offer optimal confidentiality and cyber-resilience of data exchanges in decentralized Web 3.0 (and beyond) configurations. As we continue to develop these technologies, it is essential to prioritize privacy and cybersecurity to ensure that the benefits of Web 3.0 (and beyond) are realized without compromising the security and privacy of users.

Applications in the industry for the present invention are numerous. While designed to be industry-agnostic, healthcare and renewable energy are two industries where the implementation of our innovation may have the highest impact and demonstrate its value proposition. Our innovation offers a range of benefits by facilitating secure data collection, storage, and transmission, leveraging cutting-edge technologies. With the exponential increase in data generation, several interconnected devices, cloud storage, and cyber risks, our innovative platform provides an efficient, effective, and cohesive engineering solution to ensure the privacy and confidentiality of data exchanges, mitigate current and future cyber risks, and provide secure data storage and sharing.

The emergence of Healthcare 5.0, which emphasizes the patient as the central focus, has led to a significant increase in personal and sensitive data generated, recorded, and exchanged among stakeholders in the healthcare industry. While this has significantly improved patient care and outcomes, the risk of cyber-attacks and ethical violations has increased. Healthcare 5.0's reliance on emerging technologies has led to increases in opportunities for cybercriminals to exploit vulnerabilities in the system. Additionally, the trend toward third-party vendors for healthcare data management and processing further increases the risk of data breaches and ethical violations. These risks may include unauthorized access to personal and sensitive patient data, data tampering, including deletion of essential patient data or injection of false patient data, and identity theft. It is, therefore, crucial to implement state-of-the-art, efficient, and effective security solutions to mitigate these risks and ensure patient data privacy and confidentiality.

The healthcare industry is transitioning to the next era of Healthcare 5.0 and is rapidly adopting emerging technologies to provide better patient outcomes, higher quality care, and reduced total costs to society. However, the lack of effective and efficient interoperability and secure health information exchange (HIE) mechanisms remains a significant challenge in achieving these goals. Various initiatives have been taken at the policy and technological levels to address this issue.

The Health Information Technology for Economic and Clinical Health (HITECH) Act, which was passed as part of the American Recovery and Reinvestment Act (ARRA) of 2009, incentivized the adoption of electronic health records (EHRs) and HIE systems by healthcare providers. The Office of the National Coordinator for Health Information Technology (ONC) has been working to establish standards and policies for HIE, including the Nationwide Health Information Network (NwHIN), which is a secure, nationwide network that enables the exchange of health information among healthcare providers, public health agencies, and other stakeholders. The ONC has also launched the Interoperability Standards Advisory (ISA), which provides a list of standards and implementation specifications for interoperability.

Health information exchange may improve care coordination and quality by allowing healthcare providers to access and share patient information in a timely and secure manner. However, there are several challenges to achieving safe and effective HIE. These include technical barriers, such as the lack of interoperability between EHR systems, and legal and policy barriers related to data privacy and security.

To address these challenges, various technological solutions are being developed. One promising approach is the use of blockchain technology, which can provide a secure and decentralized platform for data sharing. Blockchain technology can ensure the integrity of health data by enabling secure transactions between parties without the need for a centralized authority. This technology may also ensure that data are not tampered with or deleted.

Another critical technological solution is edge computing, which involves processing and analyzing data at the network's edge, closer to the data source. Edge computing may reduce latency and improve data privacy and security by keeping sensitive data on local devices and servers rather than transmitting it over a network.

In addition to blockchain and edge computing, federated learning may also be used to improve the security and privacy of health data. Federated learning is a machine learning technique allowing multiple parties to train a model collaboratively without sharing their raw data.

This approach helps protect sensitive patient data while allowing healthcare providers to benefit from machine learning insights.

The healthcare industry is also exploring the use of artificial intelligence (AI) to improve patient outcomes and reduce costs. AI may analyze large volumes of health data and identify patterns and insights that inform clinical decision-making. However, the use of AI in healthcare also raises ethical and efficacy concerns related to data privacy and bias.

To address these concerns, the ONC has developed a set of ethical principles for AI in healthcare, including transparency, explainability, and accountability. These principles ensure that AI systems are developed and deployed ethically and responsibly.

Safe, secure, efficient, and user-centric Health Information Exchange is a crucial enabler of transforming and reconfiguring the healthcare ecosystem, and our invention may contribute to attaining this goal by addressing the significant challenges related to interoperability, data privacy, and security.

The transition to a net-zero economy has prompted thousands of companies worldwide to adopt renewable energy sources and emerging technologies to facilitate a complex digital transformation of a primarily analog system. However, this transformation has exponentially increased cyber risks, posing a significant challenge to privacy, data confidentiality, and other cyber threats. As companies move towards cloud-based technologies and distributed systems, the complexity of cyber threats multiplies, creating a need for a state-of-the-art, efficient, effective, integrated, safe, and cohesive engineering solution.

As defined by the United Nations, a net zero state by which the greenhouse gases (GHG) going into the atmosphere are reduced as close to zero as possible, and any residual emissions are balanced by permanent removals from the atmosphere by 2050. A net-zero-centric economy requires an interconnected ecosystem of digital devices, data, and systems. In such an ecosystem, every device or system is a potential target for cyberattacks, and a single compromised node could jeopardize the entire network. Companies adopting digitized operations must be aware of the diverse cyber threats that could arise, including unauthorized access, hacking, and data breaches. A comprehensive solution is required to protect data exchange, privacy, and confidentiality from these threats.

The solution must address the security of data transmission and storage, user authentication and authorization, access control, and vulnerability management. To ensure data privacy and confidentiality, one or more forms of encryption must be employed to safeguard sensitive data, and secure protocols must be used to authenticate users and devices. A distributed and fault-tolerant system design may minimize the risk of a single point of failure in the network, while a robust access control mechanism may limit access to sensitive data.

With the adoption of renewable energy sources and other emerging technologies, companies must be cognizant of new cyber threats that could arise. One such threat is the risk of unauthorized access to critical infrastructure, which could cause significant damage to operations and business continuity. The solution must, therefore, incorporate vulnerability management mechanisms to detect and mitigate system vulnerabilities proactively and continuously. Such mechanisms must also be regularly updated to address new continuous cyber threats.

Furthermore, the engineering solution must be efficient, effective, and cohesive while scaling seamlessly. Solutions must accommodate the needs of different industries, each with its unique set of requirements and regulations. Finally, the solution must integrate with existing systems and technologies seamlessly and allow continuous improvements and upgrades to keep up with evolving cyber threats.

### SUMMARY

The following presents a summary to provide a basic understanding of one or more embodiments of the invention. This summary is not intended to identify essential or critical elements or delineate any scope of the particular embodiments or the claims. Its sole purpose is to present concepts in a simplified form as a prelude to the more detailed description presented later.

Our proposed innovation leverages the advantages of three technologies to create a web 3.0-enabled zero-trust data sharing and data storage platform. Our platform was designed for multi-party, multi-user, high volume, secure, confidential data collection, storage, and transmission in a decentralized (web 3.0 or beyond) environment. Our solution incorporates the most secure industry standards for device authentication, and each device requires a unique identity registered and authorized by our embedded identity management system. Moreover, we use encryption schemes to improve data security, in which we encrypt sensitive data before transmission, and our innovation server decrypts data before storage in any chosen database. We deploy blockchain for data consent to surface data ownership. We create a smart contract as the consent policy to store the user's consent, specifying who is able to access the data and when the permission expires.

Furthermore, we create an attribute-based access control (ABAC) policy to manage all the third-party users who register as blockchain members. We categorize all the registered users into different levels (roles) to limit some user operations. By leveraging the unique advantages of permissioned blockchain, edge computing, and federated learning, our innovation offers unparalleled privacy, security, and reliability levers.

Our innovation platform provides technical advantages that enable a highly-effective, integrated approach to data security, confidentiality, and privacy in a Web 3.0 decentralized environment. The key benefits of this innovative solution include improved data security, faster and more efficient processing and exchange of data, and the ability to share data in the growing IoT and IIoT ecosystems without compromising sensitive information.

### BRIEF DESCRIPTION OF THE DRAWINGS

A preferred embodiment of the invention, illustrative of the best mode in which the applicant has contemplated applying the principles, is set forth in the following description and is shown in the drawings and is particularly and distinctly pointed out and set forth in the appended claims.

The embodiments are illustrated by way of example and not by way of limitation in the figures of the accompanying drawings, in which references indicate similar elements. One should note that references to “an” or “one” embodiment in this disclosure are not necessarily to the same embodiment, meaning at least one.

FIG. 1 is an illustration of a simple diagram of an edge computing system consisting of at least these main components: edge devices, edge gateways, edge storage, and a cloud-based backend.

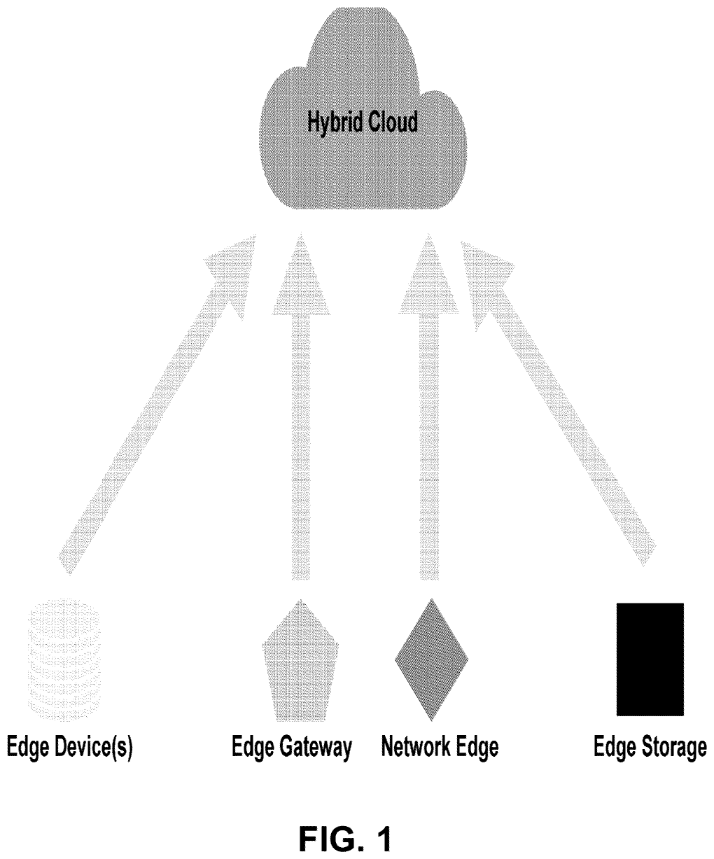

FIG. 2 is an illustration of a simple training instance via a federated learning model, which would include at least one central server, two participating devices, a local data set, secure communication protocol, one federated learning algorithm, one aggregated model, one iterative training process, one model evaluation.

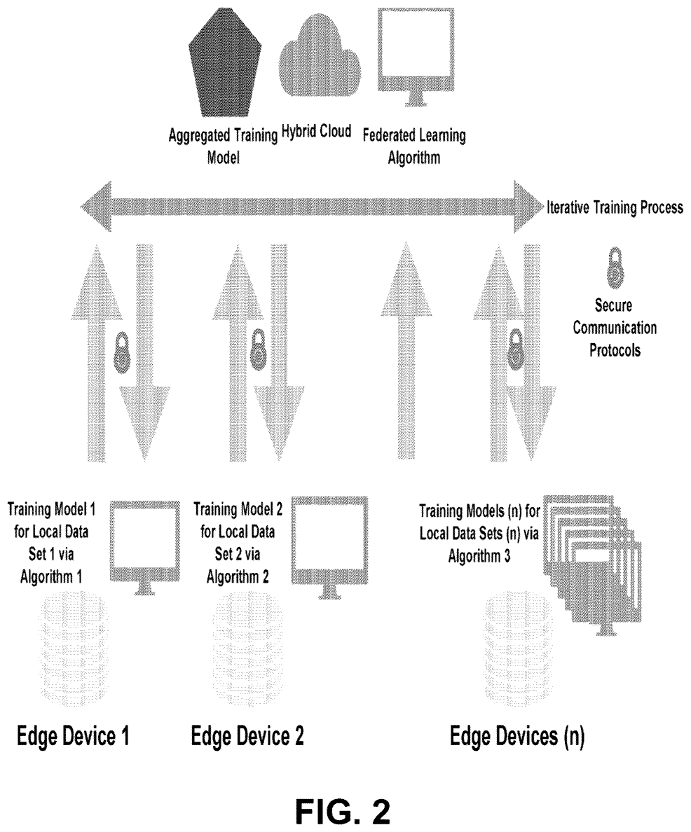

FIG. 3 is an illustration of a simple example of a permissioned blockchain including the participants that are granted permission to access the blockchain network, nodes, network, cryptographic encryption consensus mechanism, smart contract stored on the blockchain, one private data set, one public data set.

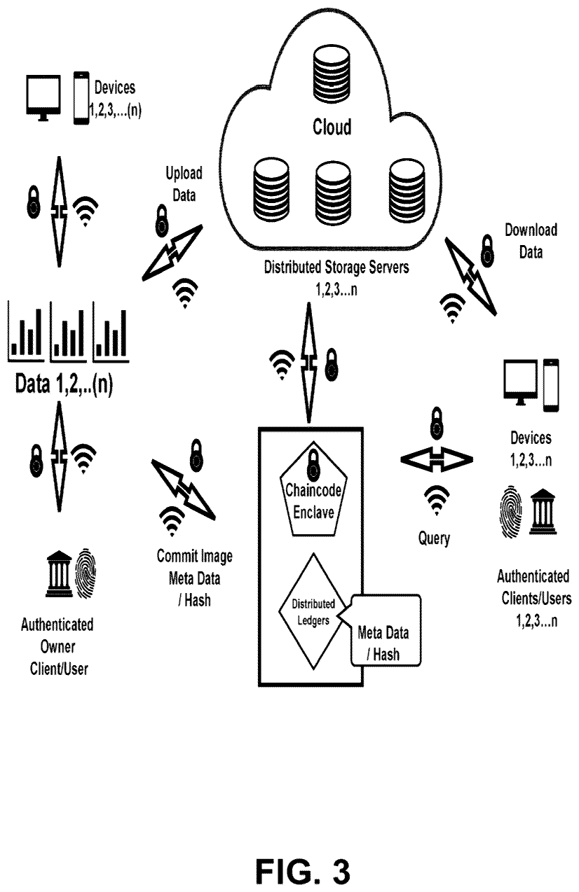

FIG. 4 is an illustration of an integrated platform that incorporates edge computing, federating learning, and permissioned blockchain.

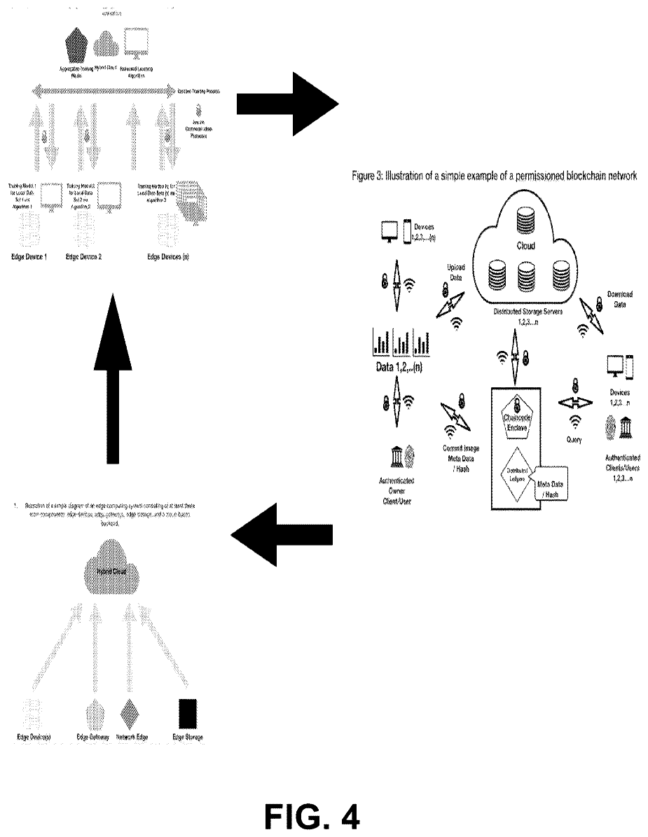

FIG. 5 illustrates a diagram of a decentralized web 3.0 architecture containing these main elements: nodes, distributed ledger, smart contract, dApps, interoperability protocol, consensus mechanism, IPFS protocol.

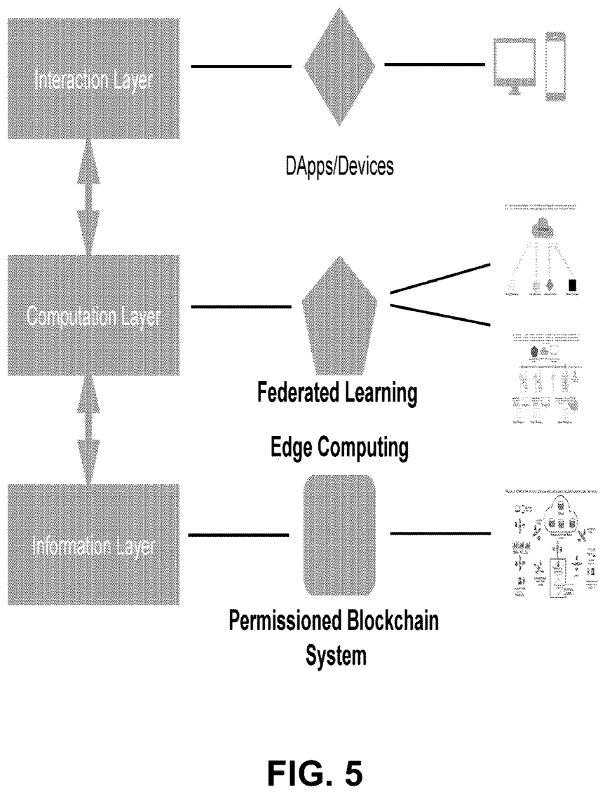

FIG. 6 Illustrates how an integrated platform incorporating edge computing, federating learning, and permissioned blockchain would operate in a Web 3.0 decentralized environment.

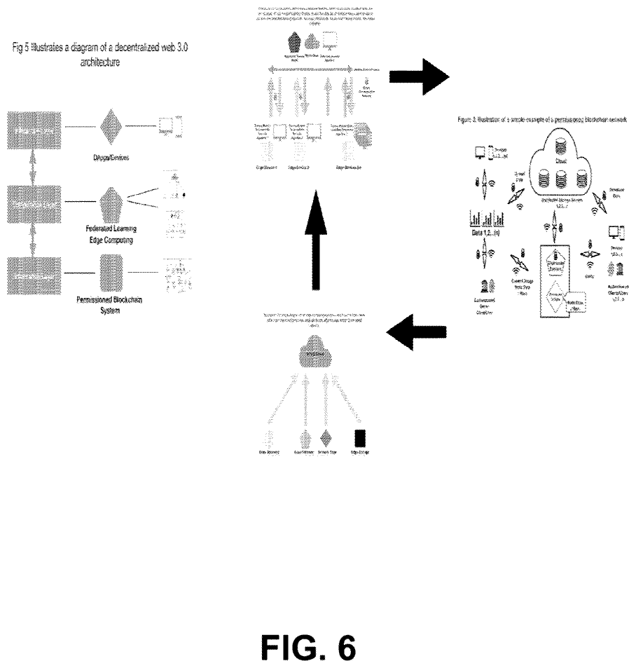

FIG. 7 Illustrates a zero trust concept including, at a minimum: initiating users or clients, authentication layer, authorization layer, encryption layer, decryption layer, logging layer, monitoring layer, automated system for detecting and responding to security incidents, policy layer, governance layer.

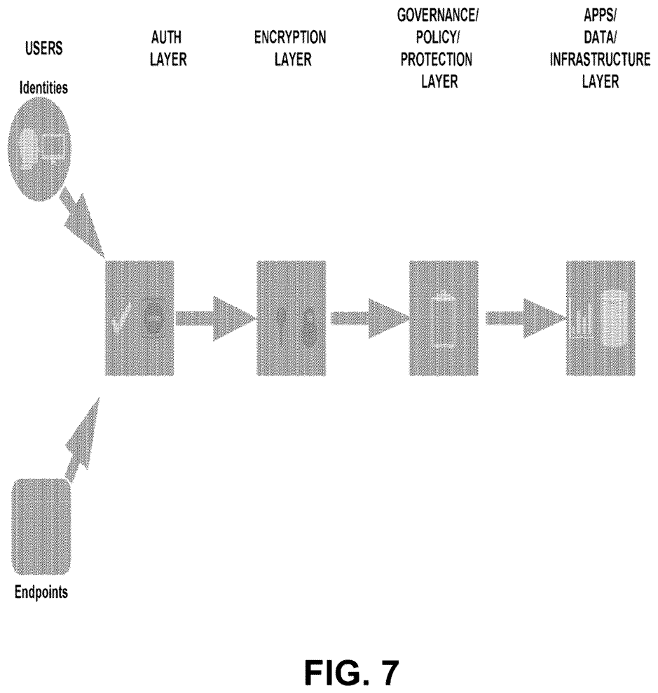

FIG. 8 Illustrates the zero-trust concept for an integrated platform that incorporates edge computing, federating learning, and permissioned blockchain that operates in a decentralized web 3.0 environment.

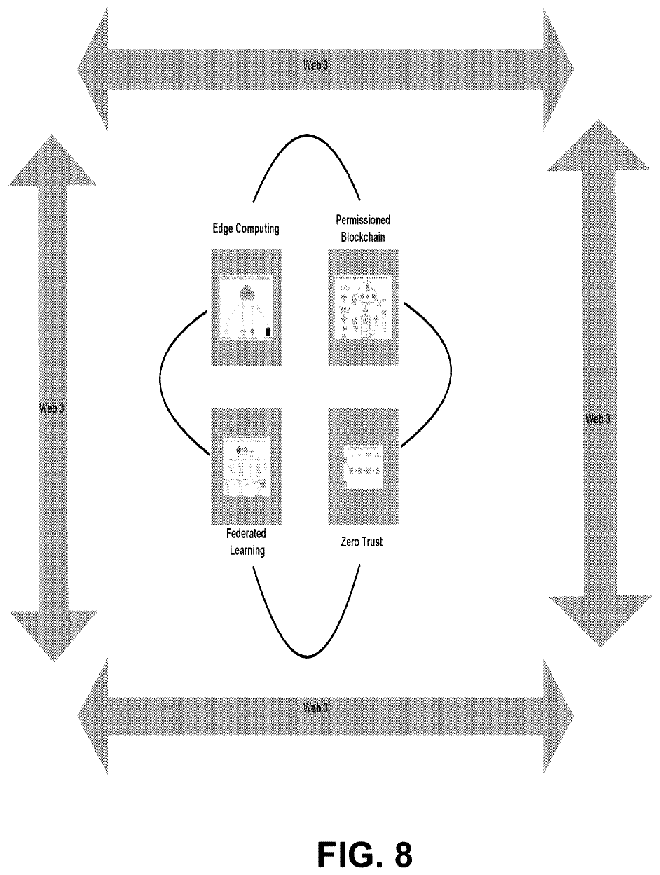

FIG. 9 illustrates an embodiment of the invention for at least one data exchange occurring in a web 3.0-enabled healthcare 5.0 environment.

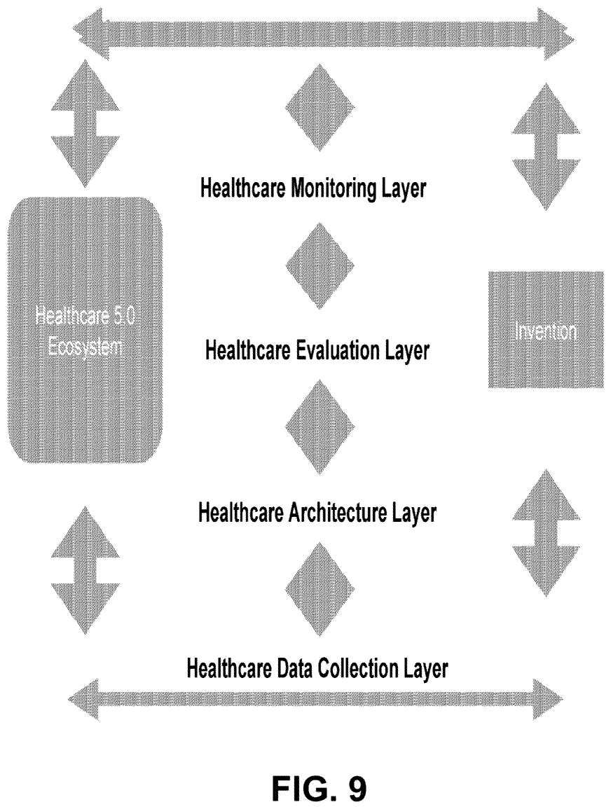

FIG. 10. Illustrates an embodiment of the invention for at least one data exchange occurring in a web 3.0-enabled renewable energy environment (net zero economy).

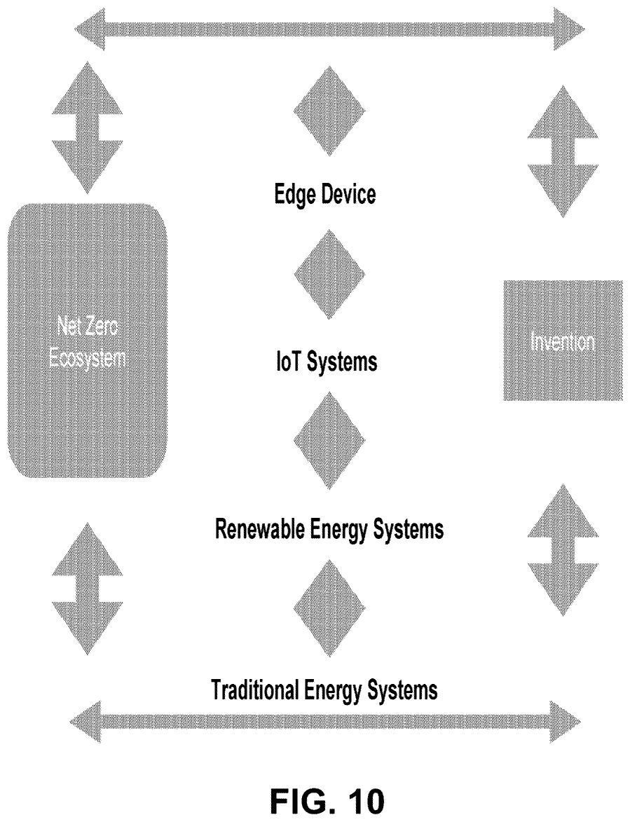

### DETAILED DESCRIPTION

The following detailed description includes references to the accompanying drawings, which form a part of the detailed description. The drawings show illustrations in accordance with the exemplary embodiments. These exemplary embodiments, referred to herein as “examples,” are described in enough detail to enable those skilled in the art to practice the present subject matter. The embodiments may be combined, other embodiments may be utilized, or structural, logical, and technical changes may be made without departing from the scope of what is claimed. Features of the embodiments described in one example may be combined with features described in a different example. The following detailed description is not to be taken in a limiting sense, and the scope is defined by the appended claims and their equivalents. With the following description, for the purpose of explanation, numerous specific details are set forth to provide a thorough understanding. One or more embodiments are be practiced without these specific details. In some examples, well-known structures and devices are described with reference to the drawings to avoid unnecessarily obscuring features and characteristics of the presently described examples. This specification may include, and the claims may recite, some examples beyond those that are described in this introductory paragraph.

The examples described herein are differentiated from all previously existing technology, as described below.

Examples described herein include an industry-agnostic platform that, in various embodiments, include these primary components: user/client, IoT device, server, network, cloud computing industry-agnostic platform, blockchain network, chaincode, node, hash, distributed ledger, secure private channel, smart contract, artificial intelligence algorithm, consensus algorithm, programming language, application programming interface, user interface, Edge Device, Edge Gateway, Edge Node, Edge Storage, and others.

Some embodiments include other technology infrastructure used for data exchanges such as screens, processors, picture archival systems, picture communication systems, data storage systems, digital imaging systems, digital communication systems, algorithms, film or paper digitization, analytics industry-agnostic platforms, local area network (LAN), wide area network (WAN), Ethernet network, Token Ring network, asynchronous transfer mode (ATM) network, Wi-Fi network, Bluetooth, RFID, near field communication (NFC), the Internet, cellular telephone network, Enhanced Data rates for GSM Evolution (EDGE) network, long-term evolution (LTE) network, 5G, infrared, satellite network, or other computing communications networks.

Some embodiments include commercial and industry-relevant devices for life sciences, healthcare, precision health, biotech, MedTech, energy industry, renewable energy industry, cyber-security, etc.

Some embodiments include a network of nodes. The nodes are local in some embodiments to and/or remote from each other in other embodiments.

Some embodiments include one or more programming languages such as Python, SQL, NoSQL, C#, Rust, Perl, Go, JavaScript, HTML, CSS, Java, etc.

Some embodiments include one or more cloud computing environments (IBM, Microsoft, Amazon, Ambra, GE, Dell, Siemens, Philips, Mayon.)

Some embodiments include a variety of standards used in industries performing confidential data exchanges, such as HL7, FHIR, DICOM, CCD, DFARS, FISMA, ISO, HIPAA, etc.

Some embodiments include a variety of APIs, API architecture types, and protocols.

Some embodiments include devices such as mobile applications, stationary or portable devices, stationary portable microcomputers, web-based applications, etc.

Techniques, methods, processes, and systems described herein enhance privacy, security, and the confidentiality of data exchanges among multiple devices, multiple clients, multiple servers, multiple environments, multiple information technology systems, multiple networks, or systems of networks.

Some embodiments include various blockchain technologies or frameworks used in various industries, such as Hyperledger, Ethereum, R3 Corda, Ripple, Quorum, Hyperledger Sawtooth, Hyperledger Fabric, IBM Blockchain, etc.

Some embodiments include a network or a system of networks. In some embodiments, a network is physical, and in others is an overlay network. Networks use various resources, such as a processor, data storage, a virtual machine, a container, and/or a software application. Network resources are shared among multiple clients, which, in some embodiments, request services from the network concomitantly and independently of each other. Networks, in some embodiments, are cloud-based and include a variety of service models.

Some embodiments include a variety of cloud-based networks, such as public, private, or hybrid cloud networks.

Some embodiments include operating systems, such as Microsoft Windows, Apple macOS, Ubuntu, Android, Apple iOS, Fedora, Solaris, Free BSD, Chrome OS, CentOS, Debian, Deepin, and others.

Some embodiments include an edge computing environment, such as at least one edge device layer, one edge network layer, one edge computing nodes layer, one edge services layer, one edge management layer, one cloud integration layer, one security layer, one privacy layer.

Some embodiments include a data layer.

Some embodiments include a network layer.

Some embodiments include a consensus layer.

Some embodiments include smart contract layer.

Some embodiments include an application layer.

Some embodiments include an identity layer.

Some embodiments include a governance layer.

Some embodiments include a zero-trust environment.

Some embodiments include a federated training model.

Some embodiments include an optimization of a federated learning model.

Some embodiments include a Pub/Sub Communication Pattern.

Techniques, methods, processes, and systems described herein enhance operational efficiency by increasing operational processing speed and reducing operational processing time.

The industry-agnostic platform described in the present disclosure demonstrates an innovative multi-system, multi-client, multi-directional precision data exchange that offer a transparent, decentralized trust network or system of networks for any protected imaging data exchanges. The trust network or system of networks offer optimal privacy, confidentiality, and security, as well as advanced identity management via e-consenting and fine-grained access control. The industry-agnostic platform enables compliance and auditability via immutability and data provenance. The industry-agnostic platform is configured to be industry-agnostic, network-agnostic, system-agnostic, server-agnostic, device-agnostic, data type-agnostic, workflow-agnostic, device-agnostic, and to be cloud-independent, and cloud-enabled. The trust network or system of networks is highly interoperable with multiple fabric blockchain networks, easily scalable, and optimizes security via integrity-protected private chain code functionality.

The industry-agnostic platform described in the present disclosure creates a trusted, decentralized, and immutable e-consenting system for all clients utilizing the industry-agnostic platform.

The industry-agnostic platform described in the present disclosure allows for self-sovereignty of data sharing for all clients utilizing the industry-agnostic platform.

The industry-agnostic platform described in the present disclosure optimizes digital identity management for all data exchange workflows.

The industry-agnostic platform described in the present disclosure enhances network access management by deploying fine-grained access control and pub/sub capabilities for all data exchange operations and workflows.

The industry-agnostic platform described in the present disclosure enhances privacy.

The industry-agnostic platform described in the present disclosure enhances confidentiality.

The industry-agnostic platform described in the present disclosure enhances auditability.

The industry-agnostic platform described in the present disclosure enhances the security.

The industry-agnostic platform described in the present disclosure enables compliance.

The industry-agnostic platform described in the present disclosure maximizes data integrity.

The industry-agnostic platform described in the present disclosure maximizes data provenance.

The industry-agnostic platform uses asynchronous binary agreement (ABA) and adaptive threshold signature for data provenance. All the transactions need to be proved and signed before being committed to the immutable ledger.

The industry-agnostic platform described in the present disclosure optimizes the operational efficiency of data exchanges by allowing off-chain storage of the actual data and by only storing all other related metadata on chain.

The industry-agnostic platform described in the present disclosure optimizes speed of data exchanges by utilizing smart contract functionality.

The industry-agnostic platform described in the present disclosure utilizes Fabric Private Chaincode (FPC) functionality.

The industry-agnostic platform described in the present disclosure is configured not to store any of the zero-trust data exchanges on the chain.

The industry-agnostic platform described in the present disclosure is configured to store the cryptography hash of the data exchange and the owner's digital signatures on the chain.

The industry-agnostic platform described in the present disclosure is configured for the use of confidentiality and integrity-protected chaincodes.

Within the industry-agnostic platform described in the present disclosure, chain codes are executed in an enclave, and execution is protected from the operating system and the hypervisor.

Within the industry-agnostic platform described in the present disclosure, chaincodes encrypt data stored on the ledger.

Within the industry-agnostic platform described in the present disclosure, the FPC chaincode establishes a secure channel.

Within the industry-agnostic platform described in the present disclosure, enclaves protect data even with the fabric blockchain network.

Within the industry-agnostic platform described in the present disclosure enclaves are programmed and verified to process and release data according to specific and fully customizable requirements or rules.

Within the industry-agnostic platform described in the present disclosure creates cryptographic encryption for key and value pairs.

In some embodiments, the industry-agnostic platform described in the present disclosure described in the present disclosure is configured for optional federated learning enablement (on/off switch of the federated learning module).

In some embodiments, the industry-agnostic platform described in the present disclosure allows a variety of multi-system and multi-client data exchange workflows in a decentralized web 3.0-enabled environment.

In some embodiments, the industry-agnostic platform described in the present disclosure allows multi-directional data exchange workflows in a decentralized web 3.0-enabled environment.

In some embodiments, the industry-agnostic platform described in the present disclosure allows a variety of operations and functions to occur concomitantly.

disclosure allows data exchanges among a multitude of clients, devices, servers, environments, and networks or systems of networks.

In some embodiments, the industry-agnostic platform described in the present disclosure is cloud-enabled and cloud independent.

In some embodiments, the industry-agnostic platform described in the present disclosure is environment and device agnostic.

In some embodiments, the industry-agnostic platform described in the present disclosure functions as an overlay with other information technology systems.

In some embodiments, the industry-agnostic platform described in the present disclosure is interoperable with any of the blockchain frameworks.

In some embodiments, the industry-agnostic platform described in the present disclosure includes edge devices such as IoT devices, smartphones, sensors, or any other type of device that generate data.

In some embodiments, the industry-agnostic platform described in the present disclosure includes an edge network infrastructure that connects edge devices to the rest of the computing infrastructure.

In some embodiments, the industry-agnostic platform described in the present disclosure includes an edge network responsible for transporting data from edge devices to the edge computing nodes and vice versa.

In some embodiments, the industry-agnostic platform described in the present disclosure includes at least one network that provides low-latency, high-bandwidth, and reliable connectivity.

disclosure includes at least one decentralized data layer using distributed ledger technology.

In some embodiments, the industry-agnostic platform described in the present disclosure includes at least one networking layer.

In some embodiments, the industry-agnostic platform described in the present disclosure includes at least one instance when the networking layer enables at least one peer-to-peer (P2P) protocol.

In some embodiments, the industry-agnostic platform described in the present disclosure includes at least one consensus layer.

In some embodiments, the industry-agnostic platform described in the present disclosure includes at least one smart contract layer.

In some embodiments, the industry-agnostic platform described in the present disclosure includes at least one application layer.

In some embodiments, the industry-agnostic platform described in the present disclosure includes at least one decentralized application (dApps) that runs on top of the Web 3.0 architecture.

In some embodiments, the industry-agnostic platform described in the present disclosure includes an edge computing nodes layer.

In some embodiments, the industry-agnostic platform described in the present disclosure processes at least one data exchange at the edge of the network.

In some embodiments, the industry-agnostic platform described in the present disclosure includes at least one server.

disclosure includes at least one gateway.

In some embodiments, the industry-agnostic platform described in the present disclosure includes at least one computing device that is deployed closer to the edge device.

In some embodiments, the industry-agnostic platform described in the present disclosure includes at least one node responsible for processing at least one data exchange locally.

In some embodiments, the industry-agnostic platform described in the present disclosure provides immediate feedback and decision-making capabilities.

In some embodiments, the industry-agnostic platform described in the present disclosure includes an edge services layer.

In some embodiments, the industry-agnostic platform described in the present disclosure includes at least one machine learning model, at least one analytics service, or at least one other type of application that is capable of processing at least one data set.

In some embodiments, the industry-agnostic platform described in the present disclosure, in some embodiments, includes at least one edge management layer.

In some embodiments, the industry-agnostic platform described in the present disclosure includes at least one system required to manage the edge computing environment.

In some embodiments, the industry-agnostic platform described in the present disclosure monitors and manages at least one edge device and one computing node.

In some embodiments, the industry-agnostic platform described in the present disclosure includes a cloud integration layer.

disclosure includes at least one integration instance between one edge computing environment and one e-cloud environment.

In some embodiments, the industry-agnostic platform described in the present disclosure includes at least one security layer.

In some embodiments, the industry-agnostic platform described in the present disclosure includes at least one instance of securing a data exchange in the edge computing environment.

In some embodiments, the industry-agnostic platform described in the present disclosure includes at least one instance of securing a device in the edge computing environment.

In some embodiments, the industry-agnostic platform described in the present disclosure includes at least one privacy layer.

In some embodiments, the industry-agnostic platform described in the present disclosure includes at least one edge server responsible for coordinating the training of the federated learning model.

In some embodiments, the industry-agnostic platform described in the present disclosure includes at least one cloud server responsible for storing the global model.

In some embodiments, the industry-agnostic platform described in the present disclosure includes at least one instance of updating the global model based on the results obtained from the edge devices.

In some embodiments, the industry-agnostic platform described in the present disclosure includes at least one communication channel to transmit at least one data set.

disclosure includes at least one instance of data updates between the edge devices and the edge and cloud servers.

In some embodiments, the industry-agnostic platform described in the present disclosure includes at least one federated learning algorithm.

In some embodiments, the industry-agnostic platform described in the present disclosure includes at least one instance of training the model in a decentralized manner.

In some embodiments, the industry-agnostic platform described in the present disclosure includes at least one instance of aggregating updates from the edge devices and updating the global model.

In some embodiments, the industry-agnostic platform described in the present disclosure includes at least one instance of data preprocessing.

In some embodiments, the industry-agnostic platform described in the present disclosure includes at least one instance of data collected from the edge devices that is used for training.

In some embodiments, the industry-agnostic platform described in the present disclosure includes at least one business rule or one predefined set of business rules is implemented.

In some embodiments, the industry-agnostic platform described in the present disclosure includes at least one policy or a predefined set of policies.

In some embodiments, the industry-agnostic platform described in the present disclosure includes at least one instance where at least one business rule or a predefined set of business rules is implemented.

disclosure includes at least one instance where at least one policy or one set of policies is implemented.

In some embodiments, the industry-agnostic platform described in the present disclosure includes a Publish-Subscribe (Pub-Sub) communication pattern.

In some embodiments, the industry-agnostic platform described in the present disclosure includes at least one instance in which publishers and subscribers are decoupled from each other through a message broker.

In some embodiments, the industry-agnostic platform described in the present disclosure includes at least one instance when at least one subscriber and one publisher would communicate with each other without being aware of each other's presence.

In some embodiments, the industry-agnostic platform described in the present disclosure includes asymmetric key cryptography.

In some embodiments, the industry-agnostic platform described in the present disclosure includes at least one digital signature.

In some embodiments, the industry-agnostic platform described in the present disclosure includes at least one hash function.

In some embodiments, the industry-agnostic platform described in the present disclosure includes at least one instance in which communication between the publisher and subscriber is secured.

In some embodiments, the industry-agnostic platform described in the present disclosure includes at least one instance in which communication between the publisher and subscriber is tamper-evident.

disclosure includes at least one instance in which multiple nodes participate in the consensus process.

In some embodiments, the industry-agnostic platform described in the present disclosure includes at least one instance in which the Pub-Sub functionality addresses at least one network failure.

In some embodiments, the industry-agnostic platform described in the present disclosure includes at least one instance in which the Pub-Sub functionality addresses at least one node failure.

In some embodiments, the industry-agnostic platform described in the present disclosure includes at least one instance in which the Pub-Sub functionality addresses at least one message loss.

In some embodiments, the industry-agnostic platform described in the present disclosure includes at least one instance in which the Pub-Sub functionality delivers at least one message to the subscribers.

In some embodiments, the industry-agnostic platform described in the present disclosure includes at least one instance in which the Pub-Sub functionality delivers at least one message without any loss.

In some embodiments, the industry-agnostic platform described in the present disclosure includes at least one instance in which the Pub-Sub functionality delivers at least one message without duplication.

disclosure includes at least one instance in which the Pub-Sub functionality supports at least one protocol implementation.

In some embodiments, the industry-agnostic platform described in the present disclosure includes at least one instance in which the Pub-Sub functionality supports at least one data format.

In some embodiments, the industry-agnostic platform described in the present disclosure, the Pub-Sub functionality supports any of the standardized protocols and formats such as MQTT, AMQP, JSON and others.

In some embodiments, the industry-agnostic platform described in the present disclosure includes at least one consensus algorithm implementation.

In some embodiments, the industry-agnostic platform described in the present disclosure includes at least one consensus algorithm implementation where the integrity of at least one data exchange was maintained across a distributed network.

In some embodiments, the industry-agnostic platform described in the present disclosure includes at least one instance when access to the blockchain is restricted to one or more authorized parties only.

In some embodiments, the industry-agnostic platform described in the present disclosure includes at least one instance when the consensus algorithm demonstrates tolerance of at least one network outage, one system crash, or at least one malicious actor.

In some embodiments, the industry-agnostic platform described in the present disclosure includes at least one instance when the algorithm ensures that all nodes in the network agree on the order of transactions.

disclosure includes at least one instance when the algorithm ensures that at least one data exchange that does not have the required consensus is rejected.

In some embodiments, the industry-agnostic platform described in the present disclosure includes utilization of a Fabric Private Chaincode

In some embodiments, the industry-agnostic platform described in the present disclosure includes at least one instance when a Fabric Private Chaincode is encrypting at least one sensitive data exchange.

In some embodiments, the industry-agnostic platform described in the present disclosure includes at least one instance when a Fabric Private Chaincode is using a secure enclave technology.

In some embodiments, the industry-agnostic platform described in the present disclosure includes at least one instance when a new data exchange is first proposed by the initiating node.

In some embodiments, the industry-agnostic platform described in the present disclosure includes at least one instance when a data exchange that was first proposed by the initiating node is then broadcasted to all other nodes in the network.

In some embodiments, the industry-agnostic platform described in the present disclosure includes at least one instance when the digital signature of a data exchange is validated.

In some embodiments, the industry-agnostic platform described in the present disclosure includes at least one instance when consensus is reached on the order of the proposed data exchange transaction.

disclosure includes at least one instance when a validated data exchange is added to the blockchain and becomes immutable.

A fabric private channel (FPC) is a private subnet of communication between two or more specific network members or organizations for the purpose of conducting private and confidential transactions.

FPC (fabric private chain code) enables the execution of chain codes inside a trusted execution environment (TEE) and a trusted ledger enclave to provide confidentiality and integrity for an industry-agnostic platform.

FPC executes chain codes in an enclave. FPC enables the execution of chain codes inside a trusted execution environment (TEE) and a trusted ledger enclave, to protect the privacy and security of chain codes and computation from potentially untrusted peer nodes, members, or organizations.

Enclaves protect FPC client data even within the fabric network.

In some embodiments, the enclave is a separated and encrypted region for codes and data in a CPU. Therefore, the enclave is only able to be decrypted inside the processor, so it is safe from the RAM being read directly. It protects the data even within the fabric network.

Execution of chain codes is isolated from the operating system and hypervisor. FPC establishes trusted execution contexts called enclaves on a CPU, which isolate data and programs from the host operating system in hardware.

All the chain codes executing on the operating system are isolated from other applications, processors, threads, and operating systems.

FPC chaincodes encrypt data stored on the ledger.

In some embodiments, FPC chain codes encrypt data stored on the ledger, and it allows a programmer to write chain code applications where the data are encrypted on the ledger and are only able to be accessed by authorized parties.

The client FPC chaincode establishes a secure channel.

The FPC establishes a secure SGX-based enclave for executing private chain code, and all the released client data will be encrypted and stored in a ledger in a channel shared with different organizations.

Enclaves are programmed and verified to process and release data according to specific requirements (regulatory, business rules, clinical rules, and other custom criteria)

The chain code execution in an enclave is a separated and encrypted region for code and data. In some embodiments, Chaincodes are be programmed and verified to process and release data according to specific requirements (regulatory, business rules, clinical rules, and other custom criteria)

Techniques, methods, processes, and systems described herein enhance operational efficiency by increasing operational processing speed and reducing operational processing time.

The model is trainable off chain and leads to enhanced privacy, security, and confidentiality of collaborative learning.

Different clients who are part of the network are able to combine, update, even share the local model to train a global model to improve its accuracy in an iterative manner.

After the local model is trained off-chain, the updated model are able be committed to the blockchain as a transaction stored in an immutable ledger.

The platform includes any combination type of data.

The platform has the capability to select the most relevant feature based on any combination of data included.

There are a few main technical advantages of combining these three technologies. One of these is the capability of a permissioned blockchain technology to provide a secure and transparent way to store and share data. It allows for the creation of tamper-proof ledgers that are only able to be accessed and updated by authorized parties, ensuring that sensitive data remains protected. Secondly, edge computing enables faster and more efficient processing of data by moving processing power closer to where data is being generated. This means that data is able to be processed in real-time, improving response times and reducing latency. Finally, federated learning allows multiple devices to collaboratively train machine learning models without exchanging sensitive data. By keeping data on the device and only sharing model updates, federated learning ensures that sensitive data remains private while still enabling machine learning models to improve over time.

Our innovation leverages these three technologies to offer a comprehensive solution for data privacy and security in decentralized Web 3.0 configurations. It provides a secure and transparent way to store and share data using a permissioned blockchain, ensuring that only authorized parties are able to access sensitive information. Edge computing enables fast and efficient data processing, allowing for real-time decision-making and response times. Federated learning enables machine learning models to improve over time without compromising the privacy of sensitive data.

In a zero-trust environment, where trust is not assumed between entities, our innovative deployment of Pub-Sub functionality is critical for efficient, secure, and confidential communication. By implementing Pub-Sub in a zero-trust environment via a permissioned BFT blockchain, we ensure a tamper-evident and transparent record of all transactions.

From an application and utilization perspective, our innovation offers a distinct competitive advantage as it is designed to be highly scalable, enabling it to handle large volumes of data across multiple devices. It is optimized for low power consumption, making it suitable for deployment in IoT and IIoT applications. Finally, it is easy to integrate with existing systems, ensuring a smooth and seamless transition to a more secure and reliable data exchange environment.

Our innovation leverages a range of security measures. For instance, device authentication is handled using the Elliptic Curve Digital Signature Algorithm (ECDSA), ensuring that each device has a unique identity that is registered and authorized by identity management. This means that Our innovation only collects data from authorized devices, providing an additional layer of security against unauthorized access.

To improve data security even further, our innovation employs encryption schemes to protect sensitive data before it is transmitted. This ensures that even if data are intercepted during transmission, the data remains encrypted and is not accessible by unauthorized parties. Once the data are received by the server, it is decrypted before storage or stored as ciphertext in the LevelDB database. This means that data remains secure at all times, whether it is being transmitted or stored.

Another important aspect of our solution is the use of blockchain technology for data consent and ownership. A smart contract is created for the consent policy to store the user's consent, outlining who is able to access the data and when permission expires. This ensures that data owners maintain control over their information and are able to determine who has access to it. Attributed-based access control (ABAC) policies are also implemented to manage third-party users who register as blockchain members. Users are categorized into different levels or roles, limiting some of their operations and ensuring that data remains secure.

By combining blockchain with edge devices (IoT), our innovation creates a zero-trust data sharing and data storage platform. This approach ensures that data remains confidential and secure while allowing for faster and more efficient processing. The use of ABAC access control, user registration, and user management further enhances security and ensures that only authorized parties have access to data.

Our innovation technology stack offers a unique solution to the challenges of web 3.0, IoT, and IIoT configurations. The core/consensus capability, Byzantine Fault Tolerance (BFT) compliance, is essential for our innovation to provide a secure and robust solution against faults and malicious actors in the system. The implementation of BFT consensus protocol for Byzantine faults and malicious attacks using BFT-SMaRt ensures the security and consistency of data in our innovation which is designed to serve as a storage system that supports authorized client read/write operations using fine-grained controls relevant to permission and zero-trust security environments described under access control. The user registration feature of our innovation ensures that only authorized users are able to access the system. The threshold encryption and BFT protocol used for user registration ensure secure and robust user registration, which is vital for securing the system.

Access control is a crucial feature in our innovation, providing decentralized confidentiality and fine-grained access control. Clients who own the data are able to decide to whom and when the data is accessible, ensuring secure multi-party information-sharing mechanisms. Different users are able to have have different access classifications, ensuring that only authorized users are able to access the data that were approved.

Another important differentiating capability in our invention is the unique application and integration of the pub/sub functionality with edge computing, federating learning and permissioned blockchain technology.

Publish-Subscribe (PubSub), is a messaging pattern that is widely used in distributed computing systems, including permissioned blockchain and federated learning systems. This pattern allows for efficient communication between multiple nodes, where the publisher sends messages to a group of subscribers without having to know their identities or specific locations. In this context, there are several advantages of using PubSub in permissioned blockchain and federated learning systems.

First, PubSub enables real-time updates and event-driven communication, which is essential in permissioned blockchain networks that require consistent updates and data synchronization among different nodes. With PubSub, any changes made to the blockchain data are immediately propagated to all subscribers, ensuring that all nodes have the most up-to-date information.

Second, PubSub is a scalable and fault-tolerant communication mechanism. In federated learning systems, PubSub is used to distribute model updates and aggregated results among edge devices, which sometimes operate under unreliable network conditions or has limited computing resources. PubSub ensures that each device receives the necessary data without overloading the network or individual devices. Additionally, PubSub allows for redundancy and failover mechanisms, where backup subscribers are able to take over if a primary subscriber fails or disconnects.

Third, PubSub enables privacy and security in distributed computing systems. In permissioned blockchain networks, PubSub is able to be used to enable private transactions between specific nodes without revealing the transaction details to other subscribers. Similarly, in federated learning systems, PubSub is able to be used to distribute encrypted model updates and results, ensuring that sensitive information is protected from unauthorized access.

What is claimed is:

1. A Web 3.0-Enabled cyber-resilient data exchange system, the system configured to perform the steps of:
leveraging permissioned Blockchain, edge computing, and federated learning technology:
using encryption schemes to improve data security and chaincodes, which are executed in an enclave, with execution being protected from the operating system and the hypervisor;
optimizing data privacy by creating fine-grained attribute-based access control (ABAC), user registration, and user management combined with pub/sub functionality; and
increasing scalability by combining pub/sub functionality with a federated learning model.

2. A system comprising:
at least one client;
at least one device;
a server;
a network or system of networks;
a cloud computing environment;
an AI algorithm;
an AI training model;
an industry-agnostic set;
a fabric network;
a chain code;
a node;
a hash;
a distributed ledger;
a private channel;
a smart contract;
a consensus algorithm;
a programming language;
an application programming interface;
a user interface;
an edge device;
a learning module; and
a computation,
wherein the system is configured to use encryption schemes to improve data security and chaincodes, which are executed in an enclave, with execution being protected from the operating system and the hypervisor;
wherein the system is configured to optimize data privacy by creating fine-grained attribute-based access control (ABAC), user registration, and user management combined with pub/sub functionality; and
wherein the system is configured to increase scalability by combining pub/sub functionality with a federated learning model.

3. A method comprising the steps of:
utilizing encryption schemes with a system to improve data security and chaincodes, which are executed in an enclave, with execution being protected from the operating system and the hypervisor;
optimizing data privacy of said system by creating fine-grained attribute-based access control (ABAC), user registration, and user management combined with pub/sub functionality; and
increasing scalability of said system by combining pub/sub functionality with a federated learning model,
wherein said system includes at least one client, at least one device, a server, a network or system of networks, a cloud computing environment, an AI algorithm, an AI training model, an industry-agnostic set, a fabric network, a chain code, a node, a hash, a distributed ledger, a private channel, a smart contract, a consensus algorithm, a programming language, an application programming interface, a user interface, an edge device, a learning module, and a computation.
